(19) United States
(12) Patent Application Publication
(10) Pub. No.: US 2013/0218055 A1
(43) Pub. Date: Aug. 22, 2013

(54) CPR MONITORING SYSTEM

(71) Applicant: Helge Fossan, Stavanger (NO)

(72) Inventor: Helge Fossan, Stavanger (NO)

(73) Assignee: LAERDAL MEDICAL AS, Stavanger (NO)

(21) Appl. No.: 13/879,755

(22) PCT Filed: Oct. 20, 2011
(86) PCT No.: PCT/EP2011/068304

§ 371 Date: Apr. 16, 2013

(30) Foreign Application Priority Data
Oct. 26, 2010 (NO) 20101497

(51) Int. Cl. A61H 31/00

(52) U.S. Cl. CPC A61H 31/00
USPC 601/41

(57) ABSTRACT

The invention relates to a system for monitoring CPR performed on a manikin. The manikin comprising means for measuring at least one first parameter concerning a performed CPR, and a measuring unit for positioning on the chest of a manikin or patient during CPR comprising sensors for measuring at least one second parameter concerning a performed CPR. The system also comprising analyzing means for analyzing said first and second parameters measured during a chosen time period during a performed CPR on said manikin and evaluating the measured parameters.

This invention relates to a system for monitoring CPR (cardio-pulmonary resuscitation) performed on a manikin, the manikin comprising means for measuring at least one first parameter concerning a performed CPR.

Measuring of CPR movements at the chest of a patient or manikin simulating a patient is well known and described e.g. US patent application No. U.S.2008/312565. This publication describes devices including sensors measuring parameters indicating the quality of the CPR, for example pressure, force or acceleration sensors. These devices are often provided with means for giving real time feedback to the person performing the CPR, either by visual or acoustic indicators, so as to enable him or her to adjust the performance during the CPR.

The device described in the abovementioned patent publication is made as a compact device so that the owner may keep it with him at all times, thus increasing the probability of having the unit readily available when a situation occurs. This does, however, not remove the need for training the user and evaluating the performance in training or real situations and the unit in the abovementioned application includes a data storage where information about the performed CPR is stored for later examination.

For training CPR manikins such as the one described in International patent application No. WO2004/100107 are frequently used, either with measuring units as described above or with measuring systems in the manikin. Experience has shown that you need to repeat the training to keep the necessary skills and therefore simple manikins are placed in places where people work or where life saving may be necessary like hospitals, schools etc. The manikins should be low cost so as to be available at several places or people may forget to use them, and thus they often are inflatable units with a simple force sensitive switch to indicate the correct use of force. In these cases the indications made by the manikin may be insufficient to provide good training effect although they do provide some help.

The use of a measuring device as described in the abovementioned US patent application in combination with the manikin described in the WO application may give the user additional and possibly more advanced information about the quality of the CPR and additional feedback. It still does, however, require repeated training at certain interval to ensure that the person maintains the trained skills.

Thus it is an object of the present invention to provide an improved system for providing feedback to a person performing CPR. This object is obtained using a system as stated above and characterized as defined in the accompanying claims.

Through the invention a system is obtained providing a possibility for improving the feedback given to the person performing the CPR, during training and indicating the need for further training. This is obtained by providing measurements obtained in the manikin during CPR training which are used to adjust or calibrate the measurements performed by the measuring unit or to provide additional information about the training. These measurements may include hand position, acceleration in the chest plate and ventilation, but may also include information about the rigidity of the manikin, dimensions, the flexibility of the supporting structure, e.g. a bed, as well as the direction of the applied force. The manikin measurements are preferably transmitted to the measuring device through wireless communication for storage until the information is transferred to a suitable means for analyzing the information.

The manikin may thus be a simple unit and the CPR measuring device may be docket to a computer at a later stage for analyzing the training, evaluate the performance and indicate in which areas further training is necessary.

The invention will be described below with reference to the accompanying drawings, illustrating the invention by way of examples.

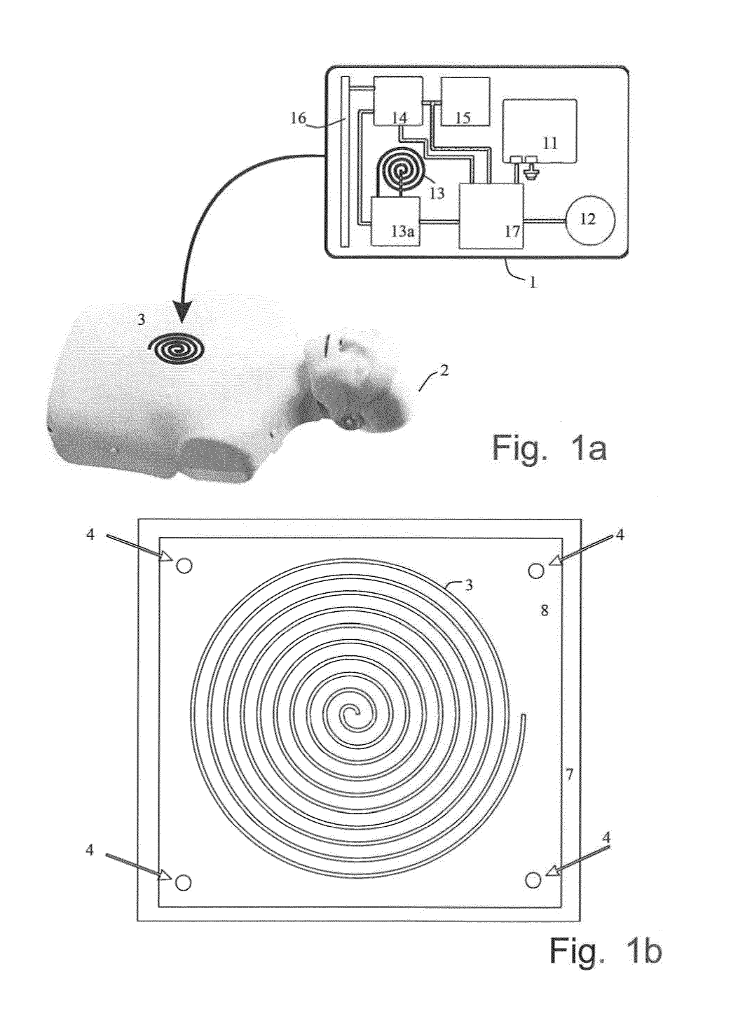

FIG. 1a illustrates the manikin and measuring unit in the system according to the preferred embodiment of the invention.

FIG. 1b illustrates the breast plate in the manikin with hand position sensors.

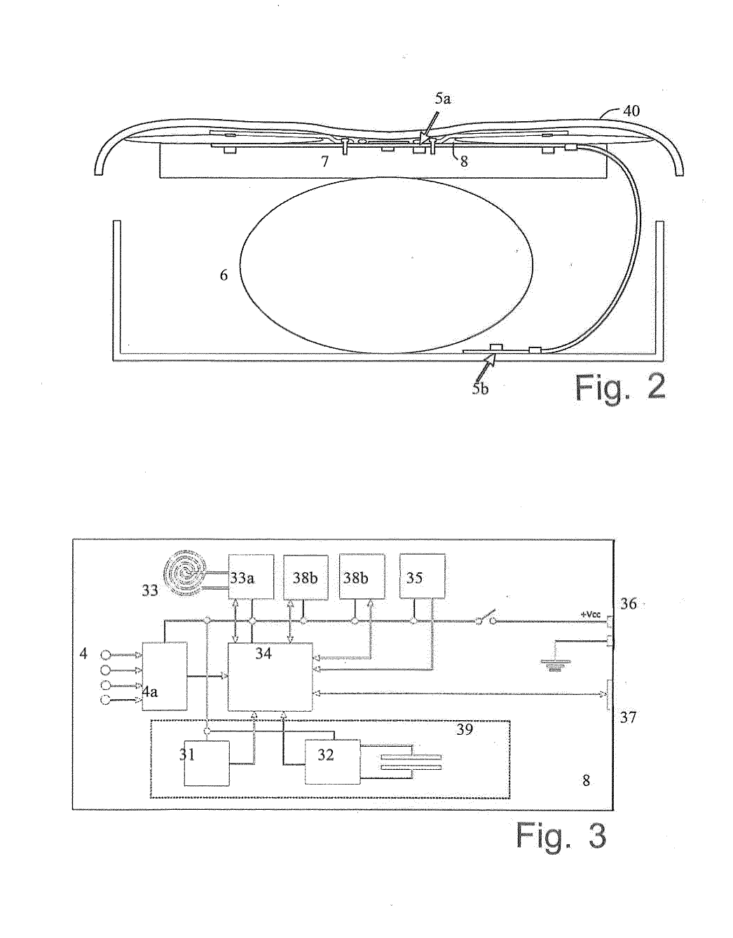

FIG. 2 illustrates the manikin in the system according to the preferred embodiment of the invention.

FIG. 3 illustrates the central circuitry of a manikin according to the preferred embodiment of the invention.

In FIG. 1a the measuring unit 1 is a card of a type similar to the one discussed in U.S.2008/312565. The measuring unit 1 includes sensors, such as an acceleration sensor 15 and measures chosen characteristics related to the CPR such as depth and frequency of the compressions, and will often also include a microcontroller 14 coupled to a feedback device 16 e.g. using light emitting diodes, for indicating the quality of the performed CPR. It may also include force sensors to detect if the force is completely released between the compressions, and the measured characteristics are stored in a memory in the card. In addition the cards is provided with an RFID device 13a and antenna 13 at least for receiving information about characteristics measured in the manikin 2, and a memory for storing the information transmitted from a corresponding communication device 3 from the manikin. The illustrated measuring unit also comprises a battery 11 and on/off switch 12 coupled to a power controller 17 which may turn the unit off automatically.

The measuring unit 1 is preferably also be provided with connecting means with an interface for communicating the stored information to an external computer and for charging the battery in the card, but it may also be possible to transfer the information using the RFID circuitry 13a and antenna 13.

Thus the card may include data recorded from real life situations as well as training situations, and in the cases where training has been performed on a manikin being able to communicate additional characteristics concerning the CPR, the manikin information is also stored in the measuring unit. Thus in these cases there are two parallel data sets, for example tagged with the same date and time or other indicators showing the relationship between them. These data may be combined to improve the evaluation of the performed CPR training.

The Manikin 2 is provided with measuring means for measuring the chosen parameters, as well as communication means 3 for communicating signals related to the measured parameters to the measuring unit 1, for example using RFID. Although RFID is used here as an example other communication means like the Bluetooth communication protocol may also be used. As illustrated in FIG. 1b four pressure sensors or similar are positioned in the manikin chest close to the antenna 3 and the ideal position for performing the CPR. The differential pressure applied to the four pressure sensors will provide an indication of the position of the applied pressure, and may thus be able to detect if the CPR is performed in the wrong place. This information may then be communicated to the measuring unit 1. As illustrated in FIG. 1b the pressure sensors 4 and antenna 3 are mounted on a printed circuit board 8 on the chest plate 7 in the manikin.

In FIG. 2 a cross section of the manikin is illustrated showing additional measuring devices being used for training purposes. Among these there may be accelerometers 5a,5b for measuring the chest compressions providing data corresponding to the data sampled by the measuring unit 1. Two accelerometers 5a,5b are preferably used so as to be able to measure the compression of the chest by removing the movements in the support, such as a soft mattress, moving ambulance etc, as the real compression is represented by the difference between the accelerometer at the chest 5a and at the back 5b.

The manikin may also include ventilation measuring means such as a bag 6 with flow sensors measuring the flow of air in and out of the bag.

FIG. 3 illustrates the circuitry, preferably mounted in the chest plate 7 of the manikin 2, including units for compression measuring devices 35 and sensors 4,4a measuring the hand position on the manikin, force sensors, chest rise sensors 31,32,39, coupled to a central control circuit 34 in the manikin. The circuitry in FIG. 3 includes connections for power input 36 and a communication an interface port 37, but the first may be exchanged with a battery and the latter may be omitted if all communication is to be provided by the control circuit 34 through the RFID antenna and RFID controller 33,33a.

The system according to the invention is preferably adapted to provide additional measurements to the measurements performed by the measuring unit or in the manikin. The information is transmitted to and stored at the measuring unit so as to provide a record of the use of the unit. This information may be analyzed on site or stored for further processing later. These processing means may be positioned independently of both manikin and measuring unit, e.g. being a computer with standard USB, RFID og Bluetooth communication with the measuring unit, and the analysis may comprise methods for comparing corresponding measurements and also for comparing other measurements performed during the same time which may be correlated to the measurements performed in the time sequence. For example a bad positioning of the compression may be correlated with large force and low compression depth.

Thus a person using the measuring unit in training at a manikin including the additional measuring units may get additional advice for further training. For example the analysis of the characteristics measured at the manikin may show that although the compressions are good the ventilation of the manikin was insufficient and further training should be performed in this area. Alternatively the hand position or the direction of the compressions may be wrong,

The system may also be provided with means for wireless charging the batteries of the measuring unit, and/or the other way around the circuitry in the manikin. Especially, a large stationary manikin may be coupled to external power and may be adapted to charge the measuring unit when in communication with the manikin. This may be performed in time windows between the information packages sent in an RFID-system.

Thus to summarize the invention relates to a system for monitoring CPR performed on a manikin, where the manikin comprises means for measuring at least one first parameter concerning a performed CPR. These parameters will preferably be hand position, ventilation and acceleration of the chest surface, but in more advanced models chest rise and back accelerometer may be used, the latter providing means for measuring the real compression.

More specifically the preferred embodiment of the invention relates to a system for monitoring CPR performed on a manikin, the manikin comprising means for measuring at least one first parameter concerning a performed CPR, and a measuring unit for positioning on the chest of a manikin or patient during CPR comprising sensors for measuring at least one second parameter concerning a performed CPR, the system also comprising analyzing means for analyzing said first and second parameters measured during a chosen time period during a performed CPR on said manikin and evaluating the measured parameters based on predetermined specifications and storing said evaluation in said measuring unit. The measuring unit preferably comprises feedback means for providing feedback to the user during a CPR based on said at least second measured parameter measured during the CPR as well as said evaluation of said first and second parameters.

Thus the measurement in the manikin and the measuring unit may be stored and analyzed later in a computer, which based on this may store a correction or calibration of the feedback given to the user when performing CPR.

The invention also relates to a measuring unit for positioning on the chest of a manikin or patient during CPR comprising sensors for measuring at least one second parameter concerning a performed CPR, such as accelerometer for calculating compression depth, and possibly the orientation of the measuring unit relative to the manikin. The system also comprises analyzing means for analyzing said first and second parameters measured during a chosen time period during a performed CPR on said manikin and evaluating the measured parameters, the analyzing means preferably are positioned in a stand alone device being capable of reading the information stored from the time period through a wireless communication or other types of interfaces.

The measuring unit is a wireless CPR sensor comprising both a sensor for measuring the compression depth during CPR and a memory unit for storing the measured parameters, and the manikin comprises at least one of the following sensors: compression depth sensor, ventilation sensor, position sensor measuring the position on the chest at which the compression is performed. According to the preferred embodiment the manikin is adapted for wireless communication of information representing the information measured by the sensors, or the CPR measuring unit, which is adapted to store the communication information for later analysis by the analyzing means.

Communication from the measuring unit to the manikin is also possible, e.g. for analyzing the results from a training class, but then requiring a more expensive manikin with storage and/or more advanced communication means.

The preferred CPR measuring device for use in the system thus includes communication means for receiving measured data from the manikin, a storage device for storing information received from the manikin and an output interface for communicating stored data both from the CPR measuring unit and from the manikin to an external computer comprising said analyzing means evaluating the measured parameters.

After analyzing the information stored in the CPR measuring device, the external computer can store a “parameter” in the CPR measuring device that can be read by the manikin during the next training session and thus adapt the training session to the trainee.

1. A system for monitoring CPR performed on a manikin, the manikin comprising:
means for measuring at least one first parameter concerning a performed CPR;
a measuring unit for positioning on the chest of the manikin during CPR, the measuring unit comprising sensors for measuring at least one second parameter concerning a performed CPR;
the system comprising analyzing means for analyzing said first and second parameters measured during a chosen time period during the performed CPR on said manikin and evaluating the measured parameters, said evaluation of said parameters being stored and the system being adapted to provide feedback to the user based on said evaluation of said first and second parameters.

2. The system according to claim 1, wherein the measuring unit is a wireless CPR sensor comprising a sensor for measuring the compression depth during CPR and a memory unit for storing the measured parameters.

3. The system according to claim 1, wherein the manikin comprises at least one of the following sensors: compression depth sensor, ventilation sensor, position sensor measuring the position on the chest at which the compression is performed.

4. The system according to claim 1, wherein the analyzing means is adapted to compare corresponding parameters measured in the measuring unit and the manikin and detecting deviations between them and recommended CPR treatment, so as to enable improved feedback to the user.

5. The system according to claim 1, wherein the manikin comprising first communication means for communicating with an independent measuring unit, the measuring unit comprising a second communication means for communicating with said first communication means.

6. The system according to claim 5, wherein the parameters measured in the manikin are communicated to the measuring unit, the measuring unit having a storage device for storing the parameters measured at both the measuring unit and the manikin.

7. The system according to claim 5, wherein the parameters measured in the measuring unit are communicated to the manikin, the manikin having a storage device for storing the parameters measured at both the measuring unit and the manikin.

8. The system according to claim 5, wherein the communication means uses electromagnetic signals.

9. The system according to clam 1, wherein said analyzing means is adapted to detect deviations between measurement in the manikin and the CPR measuring unit so as to detect errors in one of them.

10. The system according to claim 1, also comprising an external computer, wherein at least one analyzed parameter is stored and can be communicated to the manikin, e.g. during a later training session, thus providing means for adapting the training session to the stored parameter.

11. The system according to claim 1, wherein the stored parameter is related to the person performing the training, the system being adapted to identify the person and to adapt the next training session to the performing user.

12. A CPR measuring device for use in the system according to claim 1, the CPR measuring device comprising:
communication means for receiving measured data from the manikin;
a storage device for storing information received from the manikin; and
an output interface for communicating stored data from the CPR measuring unit and from the manikin to an external computer, the external computer comprising said analyzing means evaluating the measured parameters, the measuring device also comprising feedback means for providing feedback to the user during a CPR based on said at least second measured parameter measured during the CPR as well as said evaluation of said first and second parameters.
